(19) United States
(12) Patent Application Publication
(10) Pub. No.: US 2024/0221141 A1
(43) Pub. Date: Jul. 4, 2024

(54) PATTERN SEGMENTATION FOR NUISANCE SUPPRESSION

(71) Applicant: KLA Corporation, Milpitas, CA (US)

(72) Inventors: Hsiao-Min Wang, Taoyuan City (TW); Hucheng Lee, Cupertino, CA (US)

(21) Appl. No.: 18/090,447

(22) Filed: Dec. 28, 2022

(51) Int. Cl. G06T 7/00; G06T 7/12; G06T 7/136

(52) U.S. Cl. CPC G06T 7/0004; G06T 7/12; G06T 7/136; G06T 2207/30148

(57) ABSTRACT

During semiconductor wafer inspection, an image of a semiconductor wafer is divided into segments. A standard deviation for each of the segments is determined using a difference image. A threshold is then applied to each of the segments. The threshold can be a multiple of the standard deviation. Pixels in the image that include a defect are determined after applying the threshold. The pixels outside the threshold are then labeled as defects-of-interest using the processor.

### FIELD OF THE DISCLOSURE

This disclosure relates to semiconductor wafer inspection.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

As design rules shrink, however, semiconductor manufacturing processes may be operating closer to the limitation on the performance capability of the processes. In addition, smaller defects can have an impact on the electrical parameters of the device as the design rules shrink, which drives more sensitive inspections. As design rules shrink, the population of potentially yield-relevant defects detected by inspection grows dramatically, and the population of nuisance defects detected by inspection also increases dramatically. Therefore, more defects may be detected on the wafers, and correcting the processes to eliminate all of the defects may be difficult and expensive. Determining which of the defects actually have an effect on the electrical parameters of the devices and the yield may allow process control methods to be focused on those defects while largely ignoring others. Furthermore, at smaller design rules, process-induced failures, in some cases, tend to be systematic. That is, process-induced failures tend to fail at predetermined design patterns often repeated many times within the design. Elimination of spatially-systematic, electrically-relevant defects can have an impact on yield.

Some inspection methods detect repeater defects on wafers to detect defects on reticles. For example, if a defect is detected repeatedly (“a repeater defect”) at multiple locations on a wafer corresponding to the same location on a reticle, the defects may be caused by the reticle itself. Therefore, repeater defects may be analyzed to determine if they are caused by reticle defects, rather than some other cause. In general, repeater defect detection is performed as a wafer post-processing operation. For example, the inspection tool may perform normal die-to-die defect detection, and after all wafer defects are reported, the repeater defect detection may be performed in a user interface in a post-processing step rather than in a different computer component of the inspection tool. The repeater defects are defined as defects positioned at the same location (within a certain tolerance) in several dies.

Detection of systematic and other repeater defects using inspection techniques such as die-to-die inspection and die-to-standard reference die inspection are disadvantageous for a number of reasons. For example, although die-to-die inspection techniques achieved success in wafer inspection for detection of random defects, by their nature such inspection techniques are unable to detect systematic and repeater defects. In particular, by comparing two test die to each other, systematic and repeater defects that occur in both test die cannot be detected. In addition, die-to-standard reference die inspection techniques have been adopted much less than die-to-die inspection techniques in semiconductor manufacturing related applications because it is often difficult to acquire a suitable standard reference die. For example, unlike die-to-die inspection techniques in which the output for the dies that are compared is typically acquired in the same inspection scan of a wafer, die-to-standard reference die techniques often are complicated because of differences between the test die and the standard reference die (or the test wafer and the standard reference wafer) such as color variations and because of the difficulty in achieving relatively accurate alignment between the test die and the standard reference die.

Previously, a whole die was designated as one care area (CA). An EUV PrintCheck wafer was inspected with multi-die auto thresholding (MDAT) to potentially avoid missing real repeater defects. MDAT uses multiple die information as the reference to reduce process noise and improve defect extraction. The MDAT algorithm attempts to create a perfect reference for comparison. The care area was not based on the noisiness levels of the design patterns. Noisy patterns resulted in detection of an overwhelming number of nuisance repeaters when a full die care area was used for wafer inspection.

Therefore, new techniques and systems are needed.

### BRIEF SUMMARY OF THE DISCLOSURE

A system is provided in a first embodiment. The system includes a semiconductor review system with a light source that generates a beam of light; a stage configured to hold a semiconductor wafer in a path of the beam of light; and a detector that receives the beam of light reflected from the semiconductor wafer. The system also includes a processor in electronic communication with the semiconductor review system. The processor is configured to receive an image of the semiconductor wafer that is generated using the detector; divide the image of the semiconductor wafer into a plurality of segments; determine a standard deviation for each of the segments using a difference image; apply a threshold to each of the segments; determine pixels in the image that include a defect after applying the threshold; and label the pixels outside the threshold as defects-of-interest. The threshold is a multiple of the standard deviation.

The processor can be further configured to send instructions to inspect the semiconductor wafer at locations corresponding the pixels outside the threshold.

The multiple of the standard deviation can be equal for each of the segments.

Some of the segments can have edges that encompass noisy regions of the image.

A method is provided in a second embodiment. The method includes dividing, using a processor, an image of a semiconductor wafer into a plurality of segments. Using the processor, a standard deviation for each of the segments is determined using a difference image. Using the processor, a threshold is applied to each of the segments. The threshold is a multiple of the standard deviation. Using the processor, pixels in the image that include a defect are determined after applying the threshold. The pixels outside the threshold are labeled as defects-of-interest using the processor.

The method can include inspecting the pixels outside the threshold. For example, the method can include imaging the semiconductor wafer at locations corresponding to the pixels using a semiconductor inspection system.

The method can include imaging the semiconductor wafer to generate the image.

The multiple of the standard deviation can be equal for each of the segments.

Some of the segments can have edges that encompass noisy regions of the image.

A non-transitory computer-readable storage medium is provided in a third embodiment. The non-transitory computer-readable storage medium includes one or more programs for executing the following steps on one or more computing devices. The steps include dividing an image of a semiconductor wafer into a plurality of segments; determining a standard deviation for each of the segments using a difference image; applying a threshold to each of the segments; determining pixels in the image that include a defect after applying the threshold; and labeling the pixels outside the threshold as defects-of-interest. The threshold is a multiple of the standard deviation.

The steps can include sending instructions to inspect the semiconductor wafer at locations corresponding the pixels outside the threshold.

The multiple of the standard deviation can be equal for each of the segments.

Some of the segments can have edges that encompass noisy regions of the image.

### DESCRIPTION OF THE DRAWINGS

For a fuller understanding of the nature and objects of the disclosure, reference should be made to the following detailed description taken in conjunction with the accompanying drawings, in which:

FIG. 1 is a flowchart of a method in accordance with the present disclosure;

FIG. 2 is an exemplary segmentation map generated from a design file and an inspection image;

FIG. 3 is an exemplary MDAT cloud when noisy patterns are present in the frame, wherein the squares are detected defective pixels from noisy patterns;

FIG. 4 is an exemplary one-dimensional signal-to-noise ratio (1DSNR) histogram for a noisy pattern segment; and

FIG. 5 is an exemplary system in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

If not detected, mask repeater defects cause yield loss on every reticle that is printed. Without proper segmentation, noisy patterns can cause a high number of nuisance repeaters being detected with process of record (POR) full die care area MDAT. It is difficult and time-consuming to identify and separate real yield-killing repeaters from nuisance repeaters. As disclosed herein, nuisance repeaters from noisy patterns can be suppressed without sacrificing sensitivity to real repeaters. This provides a faster time-to-result. The embodiments disclosed herein segment patterns based on noisiness levels and use the segmentation map to inspect for nuisance repeater suppression. For example, wafers formed using extreme ultraviolet (EUV) lithography can be inspected. Noisy patterns can be segmented from quiet patterns based on noisiness levels of patterns. By using the 1DSNR detection algorithm disclosed herein the same 1DSNR ratio can be applied to all segments. An effective threshold for noisy patterns will be higher than quiet patterns because of the higher standard deviation.

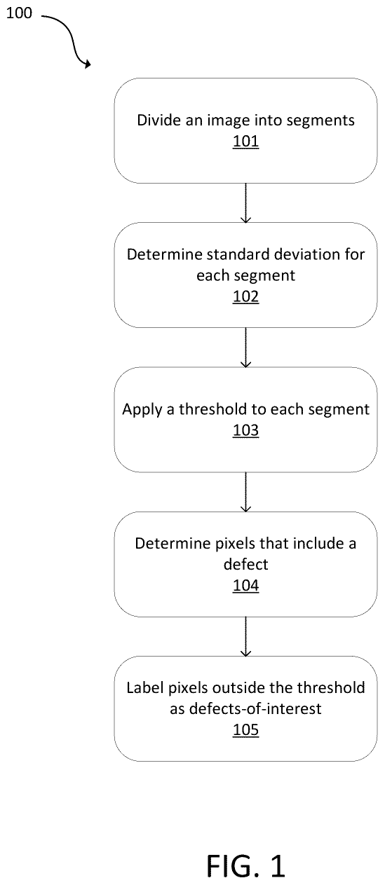

FIG. 1 is a flowchart of a method 100. Some or all of the steps in the method 100 can be performed using a processor. The method 100 can apply to any device, semiconductor wafer, or other workpiece with noisy patterns.

An image of a semiconductor wafer is divided into a plurality of segments at 101. The image can be generated by imaging the semiconductor wafer. For example, an optical inspection system or optical review system can be used to generate the image.

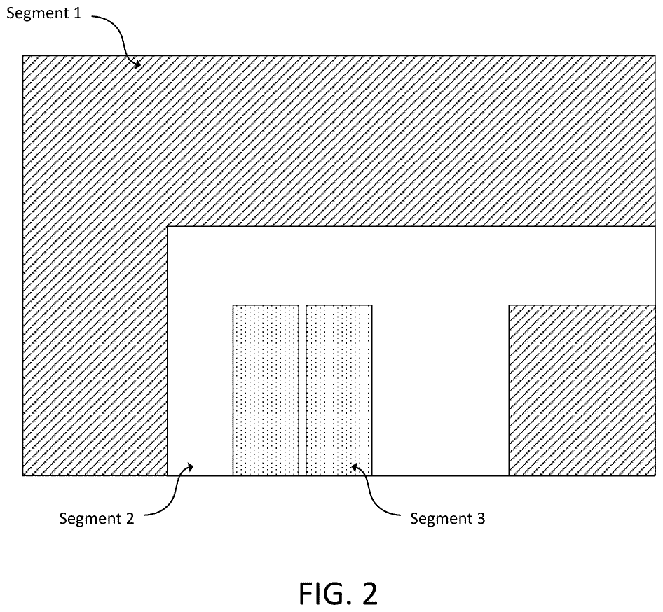

In an instance, the segmentation map is based on a design file for the semiconductor wafer. FIG. 2 is an exemplary segmentation map. Inspection is typically done on short loop after-develop inspection (ADI) or after-etch inspection (AEI) wafers. This can occur with wafers formed using EUV lithography. For segmentation map generation, design files from the current inspection step can be used. Patterns can be assigned to their respective segments based on their noisiness levels as shown in FIG. 2. In FIG. 2, each shade or pattern represents one segment. In this way, noisy patterns can be separated from quiet patterns. The patterns can be separated into different segments based on their context. For example, the underlying design of the device can be used as at least part of the context. In another example, noisiness can be used as at least part of the context.

Using the embodiments of the method 100, the different regions of the segmentation map can correspond to care areas during inspection. A noisy pattern with bigger variation can be subject to a more rigorous inspection. Quieter segments can be subject to a less rigorous inspection.

Turning back to FIG. 1, a standard deviation for each of the segments is determined at 102 using a difference image. Standard deviation can be determined assuming Gaussian distribution of noise. The difference image can use a test image (e.g., the image being evaluated) and a reference image (e.g., a neighboring die or a synthetic image using neighboring dies).

A threshold is applied to each of the segments at 103. The threshold is a multiple of the standard deviation. The multiple of the standard deviation can be equal for each of the segments. For example, a multiple of five times the standard deviation will provide a different threshold for noisy regions versus quiet areas because of the standard deviation. Thus, nuisance can be suppressed using this threshold. The threshold may be determined by how many outliers (defects) a user wants to detect. The number of outliers can depend on how defective (clean) the wafer is.

Pixels in the image that include a defect are then determined at 104 after the threshold is applied. For example, high sensitivity repeater detection can be performed using broadband plasma (BBP) optical wafer inspection. BBP wafer inspection can leverage a 190-260 nm wavelength range that provides high sensitivity for critical defect types at high throughput required for reticle re-qualification. This print check solution enables repeater sensitivity using techniques to maximize signal, minimize overall noise, and achieve a sufficient signal-to-noise ratio.

The pixels outside the threshold are labelled as defects-of-interest at 105.

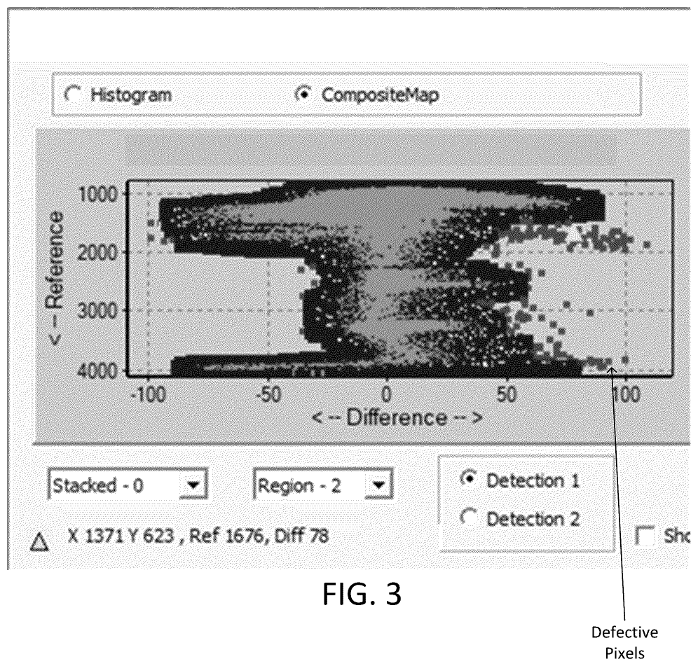

FIG. 3 is an exemplary MDAT cloud when noisy patterns are present in the frame. The squares are detected defective pixels from noisy patterns. When noisy patterns are present in the frame, those noisy patterns tend to have high variation in difference grey levels and the MDAT cloud will be sparse for those noisy patterns. These can easily become outliers as shown in FIG. 3. As a result, numerous defective pixels will be detected, and an overwhelming volume of nuisance repeaters may be reported in the lot results.

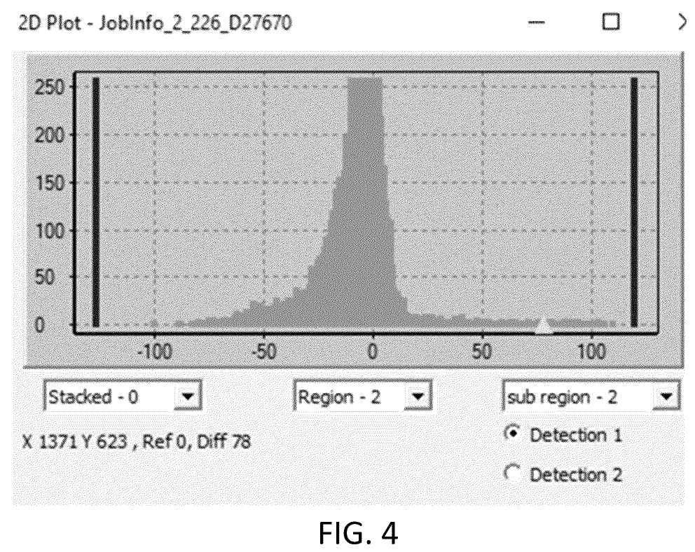

FIG. 4 is an exemplary 1DSNR histogram for a noisy pattern segment. Using embodiments disclosed herein, the standard deviation of each segment is calculated from the difference image in the frame inspected and used in detection. The standard deviation will be high for a noisy segment and low for a quiet segment. With the same 1DSNR ratio used in detection, the effective threshold applied to the noisy segment will be higher than quiet segment. As shown in FIG. 4, the same pixels from noisy patterns that are detected as defective with MDAT are now normal with 1DSNR.

The vertical bars in FIG. 4 indicates how many pixels have the particular difference grey level. Defective pixels can have difference grey level higher than the applied threshold (vertical bars). In the example of FIG. 4, there is no pixel above the 1DSNR threshold for that segment.

The method 100 can further include inspecting the pixels outside the threshold. For example, the semiconductor wafer can be imaged at locations corresponding to the pixels using a semiconductor inspection system. Further steps may be used to determine if the defects are repeaters. For example, a local signal-to-noise ratio, a repeater threshold, or other metrics may be used.

Some of the segments can have edges that encompass noisy regions of the image. When noisy patterns are segmented from quiet patterns using embodiments disclosed herein, the overwhelming nuisance repeaters that were detected with previous techniques are reduced.

The embodiments disclosed herein can avoid nuisance suppression techniques by focusing on real defects. Nuisance suppression techniques can be problematic because the attributes in a particular defect are not always known.

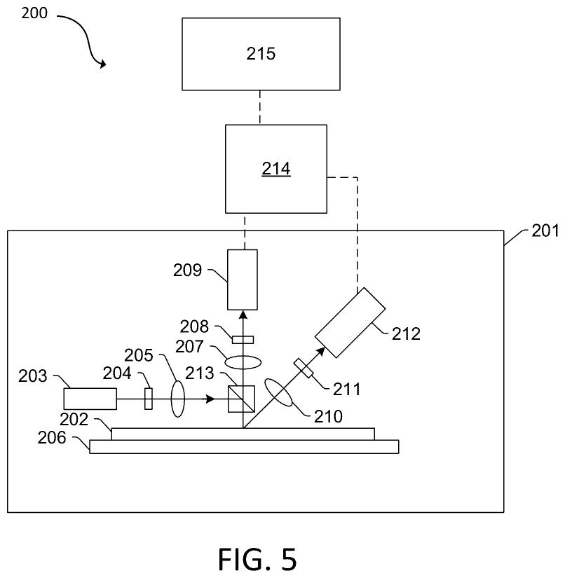

One embodiment of a system 200 is shown in FIG. 5. The system 200 includes optical based subsystem 201. In general, the optical based subsystem 201 is configured for generating optical based output for a specimen 202 by directing light to (or scanning light over) and detecting light from the specimen 202. In one embodiment, the specimen 202 includes a wafer. The wafer may include any wafer known in the art. In another embodiment, the specimen 202 includes a reticle. The reticle may include any reticle known in the art.

In the embodiment of the system 200 shown in FIG. 5, optical based subsystem 201 includes an illumination subsystem configured to direct light to specimen 202. The illumination subsystem includes at least one light source. For example, as shown in FIG. 5, the illumination subsystem includes light source 203. In one embodiment, the illumination subsystem is configured to direct the light to the specimen 202 at one or more angles of incidence, which may include one or more oblique angles and/or one or more normal angles. For example, as shown in FIG. 5, light from light source 203 is directed through optical element 204 and then lens 205 to specimen 202 at an oblique angle of incidence. The oblique angle of incidence may include any suitable oblique angle of incidence, which may vary depending on, for instance, characteristics of the specimen 202.

The optical based subsystem 201 may be configured to direct the light to the specimen 202 at different angles of incidence at different times. For example, the optical based subsystem 201 may be configured to alter one or more characteristics of one or more elements of the illumination subsystem such that the light can be directed to the specimen 202 at an angle of incidence that is different than that shown in FIG. 5. In one such example, the optical based subsystem 201 may be configured to move light source 203, optical element 204, and lens 205 such that the light is directed to the specimen 202 at a different oblique angle of incidence or a normal (or near normal) angle of incidence.

In some instances, the optical based subsystem 201 may be configured to direct light to the specimen 202 at more than one angle of incidence at the same time. For example, the illumination subsystem may include more than one illumination channel, one of the illumination channels may include light source 203, optical element 204, and lens 205 as shown in FIG. 5 and another of the illumination channels (not shown) may include similar elements, which may be configured differently or the same, or may include at least a light source and possibly one or more other components such as those described further herein. If such light is directed to the specimen at the same time as the other light, one or more characteristics (e.g., wavelength, polarization, etc.) of the light directed to the specimen 202 at different angles of incidence may be different such that light resulting from illumination of the specimen 202 at the different angles of incidence can be discriminated from each other at the detector(s).

In another instance, the illumination subsystem may include only one light source (e.g., light source 203 shown in FIG. 5) and light from the light source may be separated into different optical paths (e.g., based on wavelength, polarization, etc.) by one or more optical elements (not shown) of the illumination subsystem. Light in each of the different optical paths may then be directed to the specimen 202. Multiple illumination channels may be configured to direct light to the specimen 202 at the same time or at different times (e.g., when different illumination channels are used to sequentially illuminate the specimen). In another instance, the same illumination channel may be configured to direct light to the specimen 202 with different characteristics at different times. For example, in some instances, optical element 204 may be configured as a spectral filter and the properties of the spectral filter can be changed in a variety of different ways (e.g., by swapping out the spectral filter) such that different wavelengths of light can be directed to the specimen 202 at different times. The illumination subsystem may have any other suitable configuration known in the art for directing the light having different or the same characteristics to the specimen 202 at different or the same angles of incidence sequentially or simultaneously.

In one embodiment, light source 203 may include a broadband plasma (BBP) source. In this manner, the light generated by the light source 203 and directed to the specimen 202 may include broadband light. However, the light source may include any other suitable light source such as a laser. The laser may include any suitable laser known in the art and may be configured to generate light at any suitable wavelength or wavelengths known in the art. In addition, the laser may be configured to generate light that is monochromatic or nearly-monochromatic. In this manner, the laser may be a narrowband laser. The light source 203 may also include a polychromatic light source that generates light at multiple discrete wavelengths or wavebands.

Light from optical element 204 may be focused onto specimen 202 by lens 205. Although lens 205 is shown in FIG. 5 as a single refractive optical element, it is to be understood that, in practice, lens 205 may include a number of refractive and/or reflective optical elements that in combination focus the light from the optical element to the specimen. The illumination subsystem shown in FIG. 5 and described herein may include any other suitable optical elements (not shown). Examples of such optical elements include, but are not limited to, polarizing component(s), spectral filter(s), spatial filter(s), reflective optical element(s), apodizer(s), beam splitter(s) (such as beam splitter 213), aperture(s), and the like, which may include any such suitable optical elements known in the art. In addition, the optical based subsystem 201 may be configured to alter one or more of the elements of the illumination subsystem based on the type of illumination to be used for generating the optical based output.

The optical based subsystem 201 may also include a scanning subsystem configured to cause the light to be scanned over the specimen 202. For example, the optical based subsystem 201 may include stage 206 on which specimen 202 is disposed during optical based output generation. The scanning subsystem may include any suitable mechanical and/or robotic assembly (that includes stage 206) that can be configured to move the specimen 202 such that the light can be scanned over the specimen 202. In addition, or alternatively, the optical based subsystem 201 may be configured such that one or more optical elements of the optical based subsystem 201 perform some scanning of the light over the specimen 202. The light may be scanned over the specimen 202 in any suitable fashion such as in a serpentine-like path or in a spiral path.

The optical based subsystem 201 further includes one or more detection channels. At least one of the one or more detection channels includes a detector configured to detect light from the specimen 202 due to illumination of the specimen 202 by the subsystem and to generate output responsive to the detected light. For example, the optical based subsystem 201 shown in FIG. 5 includes two detection channels, one formed by collector 207, element 208, and detector 209 and another formed by collector 210, element 211, and detector 212. As shown in FIG. 5, the two detection channels are configured to collect and detect light at different angles of collection. In some instances, both detection channels are configured to detect scattered light, and the detection channels are configured to detect light that is scattered at different angles from the specimen 202. However, one or more of the detection channels may be configured to detect another type of light from the specimen 202 (e.g., reflected light).

As further shown in FIG. 5, both detection channels are shown positioned in the plane of the paper and the illumination subsystem is also shown positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 210, element 211, and detector 212 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 5 shows an embodiment of the optical based subsystem 201 that includes two detection channels, the optical based subsystem 201 may include a different number of detection channels (e.g., only one detection channel or two or more detection channels). In one such instance, the detection channel formed by collector 210, element 211, and detector 212 may form one side channel as described above, and the optical based subsystem 201 may include an additional detection channel (not shown) formed as another side channel that is positioned on the opposite side of the plane of incidence. Therefore, the optical based subsystem 201 may include the detection channel that includes collector 207, element 208, and detector 209 and that is centered in the plane of incidence and configured to collect and detect light at scattering angle(s) that are at or close to normal to the specimen 202 surface. This detection channel may therefore be commonly referred to as a “top” channel, and the optical based subsystem 201 may also include two or more side channels configured as described above. As such, the optical based subsystem 201 may include at least three channels (i.e., one top channel and two side channels), and each of the at least three channels has its own collector, each of which is configured to collect light at different scattering angles than each of the other collectors.

As described further above, each of the detection channels included in the optical based subsystem 201 may be configured to detect scattered light. Therefore, the optical based subsystem 201 shown in FIG. 5 may be configured for dark field (DF) output generation for specimens 202. However, the optical based subsystem 201 may also or alternatively include detection channel(s) that are configured for bright field (BF) output generation for specimens 202. In other words, the optical based subsystem 201 may include at least one detection channel that is configured to detect light specularly reflected from the specimen 202. Therefore, the optical based subsystems 201 described herein may be configured for only DF, only BF, or both DF and BF imaging. Although each of the collectors are shown in FIG. 5 as single refractive optical elements, it is to be understood that each of the collectors may include one or more refractive optical die(s) and/or one or more reflective optical element(s).

The one or more detection channels may include any suitable detectors known in the art. For example, the detectors may include photo-multiplier tubes (PMTs), charge coupled devices (CCDs), time delay integration (TDI) cameras, and any other suitable detectors known in the art. The detectors may also include non-imaging detectors or imaging detectors. In this manner, if the detectors are non-imaging detectors, each of the detectors may be configured to detect certain characteristics of the scattered light such as intensity but may not be configured to detect such characteristics as a function of position within the imaging plane. As such, the output that is generated by each of the detectors included in each of the detection channels of the optical based subsystem may be signals or data, but not image signals or image data. In such instances, a processor such as processor 214 may be configured to generate images of the specimen 202 from the non-imaging output of the detectors. However, in other instances, the detectors may be configured as imaging detectors that are configured to generate imaging signals or image data. Therefore, the optical based subsystem may be configured to generate optical images or other optical based output described herein in a number of ways.

It is noted that FIG. 5 is provided herein to generally illustrate a configuration of an optical based subsystem 201 that may be included in the system embodiments described herein or that may generate optical based output that is used by the system embodiments described herein. The optical based subsystem 201 configuration described herein may be altered to optimize the performance of the optical based subsystem 201 as is normally performed when designing a commercial output acquisition system. In addition, the systems described herein may be implemented using an existing system (e.g., by adding functionality described herein to an existing system). For some such systems, the methods described herein may be provided as optional functionality of the system (e.g., in addition to other functionality of the system). Alternatively, the system described herein may be designed as a completely new system.

The processor 214 may be coupled to the components of the system 200 in any suitable manner (e.g., via one or more transmission media, which may include wired and/or wireless transmission media) such that the processor 214 can receive output. The processor 214 may be configured to perform a number of functions using the output. The system 200 can receive instructions or other information from the processor 214. The processor 214 and/or the electronic data storage unit 215 optionally may be in electronic communication with a wafer inspection tool, a wafer metrology tool, or a wafer review tool (not illustrated) to receive additional information or send instructions. For example, the processor 214 and/or the electronic data storage unit 215 can be in electronic communication with a scanning electron microscope.

The processor 214, other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 214 and electronic data storage unit 215 may be disposed in or otherwise part of the system 200 or another device. In an example, the processor 214 and electronic data storage unit 215 may be part of a standalone control unit or in a centralized quality control unit. Multiple processors 214 or electronic data storage units 215 may be used.

The processor 214 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 214 to implement various methods and functions may be stored in readable storage media, such as a memory in the electronic data storage unit 215 or other memory.

If the system 200 includes more than one processor 214, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 214 may be configured to perform a number of functions using the output of the system 200 or other output. For instance, the processor 214 may be configured to send the output to an electronic data storage unit 215 or another storage medium. The processor 214 may be configured according to any of the embodiments described herein. The processor 214 also may be configured to perform other functions or additional steps using the output of the system 200 or using images or data from other sources.

Various steps, functions, and/or operations of system 200 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 214 or, alternatively, multiple processors 214. Moreover, different sub-systems of the system 200 may include one or more computing or logic systems. Therefore, the above description should not be interpreted as a limitation on the present disclosure but merely an illustration.

In an instance, the processor 214 is in communication with the system 200. The processor 214 is configured to perform some or all of the steps of method 100.

An additional embodiment relates to a non-transitory computer-readable medium storing program instructions executable on a controller for performing a computer-implemented method for detecting repeaters, as disclosed herein. In particular, as shown in FIG. 5, electronic data storage unit 215 or other storage medium may contain non-transitory computer-readable medium that includes program instructions executable on the processor 214. The computer-implemented method may include any step(s) of any method(s) described herein, including method 100.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (MFC), Streaming SIMD Extension (SSE), or other technologies or methodologies, as desired.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a semiconductor review system that includes:
a light source that generates a beam of light;
a stage configured to hold a semiconductor wafer in a path of the beam of light; and
a detector that receives the beam of light reflected from the semiconductor wafer; and
a processor in electronic communication with the semiconductor review system, wherein the processor is configured to:
receive an image of the semiconductor wafer that is generated using the detector;
divide the image of the semiconductor wafer into a plurality of segments;
determine a standard deviation for each of the segments using a difference image;
apply a threshold to each of the segments, wherein the threshold is a multiple of the standard deviation;
determine pixels in the image that include a defect after applying the threshold; and
label the pixels outside the threshold as defects-of-interest.

2. The system of claim 1, wherein the processor is further configured to send instructions to inspect the semiconductor wafer at locations corresponding the pixels outside the threshold.

3. The system of claim 1, wherein the multiple of the standard deviation is equal for each of the segments.

4. The system of claim 1, wherein some of the segments have edges that encompass noisy regions of the image.

5. A method comprising:
dividing, using a processor, an image of a semiconductor wafer into a plurality of segments;
determining, using the processor, a standard deviation for each of the segments using a difference image;
applying, using the processor, a threshold to each of the segments, wherein the threshold is a multiple of the standard deviation;
determining, using the processor, pixels in the image that include a defect after applying the threshold; and
labeling the pixels outside the threshold as defects-of-interest using the processor.

6. The method of claim 5, further comprising inspecting the pixels outside the threshold.

7. The method of claim 6, further comprising imaging the semiconductor wafer at locations corresponding to the pixels using a semiconductor inspection system.

8. The method of claim 5, further comprising imaging the semiconductor wafer to generate the image.

9. The method of claim 5, wherein the multiple of the standard deviation is equal for each of the segments.

10. The method of claim 5, wherein some of the segments have edges that encompass noisy regions of the image.

11. A non-transitory computer-readable storage medium, comprising one or more programs for executing the following steps on one or more computing devices:
dividing an image of a semiconductor wafer into a plurality of segments;
determining a standard deviation for each of the segments using a difference image;
applying a threshold to each of the segments, wherein the threshold is a multiple of the standard deviation;
determining pixels in the image that include a defect after applying the threshold; and
labeling the pixels outside the threshold as defects-of-interest.

12. The non-transitory computer-readable storage medium of claim 11, wherein the steps further include sending instructions to inspect the semiconductor wafer at locations corresponding the pixels outside the threshold.

13. The non-transitory computer-readable storage medium of claim 11, wherein the multiple of the standard deviation is equal for each of the segments.

14. The non-transitory computer-readable storage medium of claim 11, wherein some of the segments have edges that encompass noisy regions of the image.
